(19) United States
(12) Patent Application Publication
(10) Pub. No.: US 2006/0221864 A1
(43) Pub. Date: Oct. 5, 2006

(54) Method and apparatus for determining a best technique to use when locating a node

(76) Inventors: Feng Niu, Weston, FL (US); Spyros Kyperountas, Weston, FL (US); Qicai Shi, Coral Springs, FL (US)

Correspondence Address: MOTOROLA, INC., 1303 EAST ALGONQUIN ROAD, IL01/3RD, SCHAUMBURG, IL, 60196, US

(21) Appl. No.: 11/093,609

(22) Filed: Mar. 30, 2005

(51) Int. Cl. H04L 12/28

(52) U.S. Cl. 370/255

(57) ABSTRACT

A method and apparatus for determining a best technique (algorithm and/or parameters) to use when locating a node (104) is provided herein. In particular, reference nodes (105) are provided that not only know their own locations, but also test various algorithms and parameters by estimating their locations as if they were blind nodes. The reference nodes then evaluates these various techniques against the user defined criteria for the best technique. Recommendations as to the best technique to utilize are then made to other nodes within the system.

### FIELD OF THE INVENTION

The present invention relates generally to location and in particular, to a method and apparatus for determining a best technique to use when locating a remote unit.

### BACKGROUND OF THE INVENTION

A variety of systems have been proposed which call for the ability to locate an object. For example, in asset control, it would be desirable to locate objects (e.g., laptop computers) within the confines of an office building. It is also desirable to be able to locate a cellular phone user for emergency service purposes.

All location systems consists of two basic types of nodes, those with known locations, usually referred to as anchor nodes or reference nodes, and those with unknown locations, usually referred to as blind nodes, or blindfolded nodes. The reference nodes provide reference locations, which are used by the blind nodes to determine their location. More particularly, the measurements between nodes provide some quantitative measure of the relationship between nodes (closeness, for example). Algorithms then estimate the locations of blind nodes based on the reference locations and measurement data. The algorithms may be executed at centralized location finding equipment, the blind nodes, or reference nodes.

There exist many different location techniques suited for location estimation. These techniques include, but are not limited to a signpost algorithm, a generic weighted-average technique, a triangulation technique, a multi-lateration technique, a maximum likelihood algorithm, and a Global Positioning System technique.

Because there are many different location techniques, many nodes have the ability to locate themselves via one of several available techniques. There are many factors to be considered when selecting which available algorithm to use in locating a device, which makes this task difficult for blind nodes to do. Therefore, a need exists for a method and apparatus for determining a best algorithm and/or parameters to use when locating a node.

### BRIEF DESCRIPTION OF THE DRAWINGS

FIG. 1 is illustrates a typical floor plan of an office building in which are located a number of wireless devices involved in determining each other's location.

FIG. 2 is a block diagram of a node.

FIG. 3 is a flow chart showing operation of the node of FIG. 2.

FIG. 4 is a flow chart showing operation of the node of FIG. 2.

### DETAILED DESCRIPTION OF THE DRAWINGS

In order to address the above-mentioned need, a method and apparatus for determining a best technique (algorithm and/or parameters) to use when locating a node is provided herein. In particular, reference nodes are provided that not only know their own locations, but also test various algorithms and parameters for accuracy by estimating their locations as if they were blind nodes. The reference nodes then compare their location estimates to their actual location to determine the accuracy of any technique used in location. Recommendations as to the best technique to utilize are then sent to other nodes within the system.

In the preferred embodiment of the present invention the best location technique to utilize is one that results in a best location accuracy. However, in alternate embodiments of the present invention other criteria may be utilized to determine a best location technique. For example, a technique that results in the best computation time may be used,. Similarly, one that results in a least amount of computational resources (such as memory) may be utilized.

Because any best location technique selected is completely environment dependent no prior knowledge of the environment is needed. As the environment changes, the system adapts to the environment by selecting the most suitable algorithms. The testing of the algorithms is done in the actual environment and fully automatic.

The present invention encompasses a method for determining a best location technique to use when locating a node. The method comprises the steps of receiving location data from a plurality of nodes, calculating a plurality of location estimates using a plurality of location techniques, determining the best location technique based on the plurality of location estimates. Information regarding the best location technique is provided to other nodes to utilize when performing location.

The present invention additionally encompasses a method for determining a best location technique to utilize when locating a node. The method comprises the steps of receiving location data from a plurality of reference nodes, receiving information regarding best location techniques from the plurality of reference nodes, and calculating a location estimate based on the location data and the information regarding the best location techniques.

The present invention additionally encompasses an apparatus comprising a receiver receiving location data from a plurality of nodes, logic circuitry calculating a plurality of location estimates using a plurality of location techniques, and transmit circuitry transmitting information regarding the best location technique to other nodes to utilize when performing location.

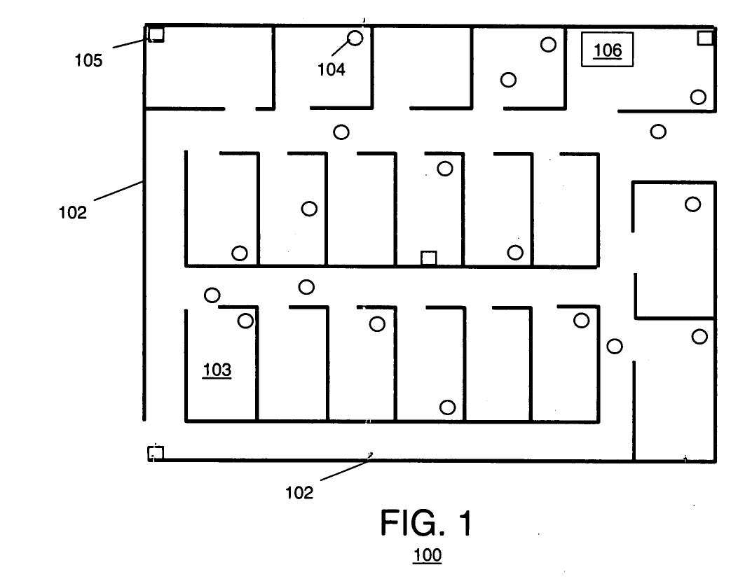

Turning now to the drawings, wherein like numerals designate like components, FIG. 1 is a floor plan 100 of an interior of an office building, in which are located a number of wireless devices 104 and 105 involved in determining each other's location. Floor plan 100 comprises perimeter wall 102 that encloses a plurality of offices 103 (only one labeled).

Circular objects 104 (only one labeled) shown on floor plan 100 represent wireless devices (remote, or mobile blind nodes), the locations of which are unknown and to be determined. Wireless devices 104 can include, for example, transceiver security tags attached to assets such as lap top computers, or wireless communication devices including cellular telephones. Rectangular objects 105 (only one labeled) represent reference devices, or nodes. The locations of devices 105 are known, or can be easily and accurately determined to within some measurement accuracy (e.g., via GPS). Reference devices 105 are utilized in determining the locations of devices 104. In various embodiments of the present invention central processing node 106 may serve as location-finding equipment (LFE) to perform calculations involved in determining the location of devices 104-105 as will be described below in more detail.

It should be noted that although FIG. 1 shows wireless devices 104-105 existing within a two-dimensional space, one of ordinary skill in the art will recognize that wireless devices 104-105 may be located in other environments, including 3-dimensional spaces. For example, wireless devices 104 may comprise golf carts equipped with wireless transceivers located on a golf course. In a similar manner, wireless devices 104 may comprise inventory located within a warehouse. Irrespective of the environment where wireless devices 104-106 operate, reference nodes 105, whose locations are known, aide in locating devices 104. Additionally, FIG. 1 shows LFE 106 existing independent of reference nodes 105, however, one of ordinary skill in the art will recognize that reference nodes 105 may comprise the necessary circuitry to perform the location estimation described below.

As described above, a variety of techniques (e.g., algorithms and parameters) have been proposed for locating wireless devices 104. A problem exists in that for prior-art systems, it is difficult for blind nodes to determine a best technique to utilize when determining its location. In order to address this issue, reference nodes 105 test various algorithms and parameters for accuracy by estimating their locations as if they were blind nodes 104. Reference nodes 105 then compare their location estimates to their actual location to determine an accuracy of any technique used in location. Recommendations as to the best technique are then made to other nodes within the system.

After determining a best technique to utilize when performing location, reference nodes may simply broadcast this technique to all nodes within communication range, or alternatively, may provide the best technique on a node-by-node basis, when polled by a particular node. Regardless of how the information is provided to other nodes within the communication system, each reference node 105 will determine a plurality of location estimates using a plurality of location techniques, compare each location estimate to an actual location, determine a best location estimate and location technique, and provide the best location technique to other nodes within the communication system.

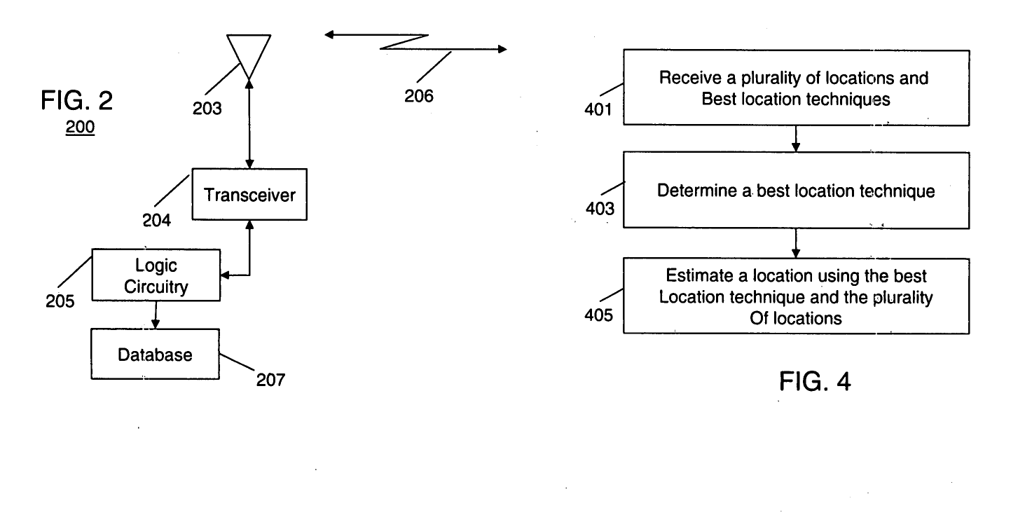

FIG. 2 is a block diagram of node 200 equipped to determine its location. Node 200 may serve as a reference node, or a blind node. Node 200 comprises antenna 203 coupled to transceiver (transmitter and receiver) 204, in turn, coupled to logic circuitry 205. Database 207 is provided and comprises a list of appropriate location techniques (parameters and algorithms) that can be utilized in determining a location estimate.

Although various forms for antenna 203, transceiver 204, and logic circuitry 205 are envisioned, in a preferred embodiment of the present invention node 200 is formed from a Freescale Inc. MC13192 transceiver 204 coupled to a Motorola HC08 8-bit processor 205. When node 200 wishes to determine its location, it receives over-the-air communication signal 206 transmitted from reference nodes 105. Communication signal 206, received from reference nodes 105 comprises a physical location of reference node 105 and information regarding a best technique to utilize when performing location estimation. In the preferred embodiment of the present invention, technique information is indexed in database 207. Communication signal 206 comprises an index value identifying an algorithm and/or variable to use.

When acting as a blind node, node 200 extracts the physical location for each reference node 105 and a best technique from each reference node 105. If differing best techniques are received from nodes 105, logic circuitry 205 will utilize a user defined criterion (such as the most identified) to select the best technique when performing location.

Once locations and best techniques are received from reference nodes 105, logic circuitry 205 calculates a location estimate using the best technique and the locations of the reference nodes. For example, if the best technique was identified as being a generic weighted-average technique, logic circuitry 205 will use the generic weighted-average technique and the locations of nodes 105 to determine its location.

As discussed, in addition to providing a best algorithm to utilize, reference nodes 105 can be used to provide the best parameters to use for a particular algorithm. For example, in the weighted average location technique the generic weighted average algorithm for estimating the coordinates (xᵢ,yᵢ,zᵢ) of a blind node i is given as follows:

$$( {x}_{i} , {y}_{i} , {z}_{i} ) = \frac{{\sum }_{j} {w}_{i , j} * ( {x}_{rj} , {y}_{rj} , {z}_{rj} )}{{\sum }_{j} {w}_{i , j}} , \qquad ( 1 )$$

where (xᵣⱼ,yᵣⱼ,zᵣⱼ) is the coordinates of the jth reference node. The weight w_{i,j} usually depends on both the ith blind node and jth reference node. Assume,
w_{i,j}=(PLₘₐₓ−PL_{i,j})^{q}, (2)
where the path loss PL is the difference between the transmitted power (Pₜ in dBm) and the measured received signal strength, or RSS (Pᵣ in dBm), i.e., if the RSS is −75 dBm and the transmitted power is 0 dBm, the path loss is 75 dB, or
PL=10*log₁₀(Pₜ)−10*log₁₀(Pᵣ) (3)
PL_{i,j} in the Eq. (2) is the path loss between the ith blind node and jth reference node. Lₘₐₓ in the Eq. (2) is the maximum path loss for the ith node at each experiment. Best parameters, such as weight exponent q may be tested and provided by reference nodes 105.

It should be noted, that while the above discussion had blind nodes calculating their own locations, in an alternate embodiment of the present invention, location finding equipment (LFE) 106 may be utilized to estimate a blind node's location. In this situation, blind nodes 104 will provide the parameters needed to determine a location to LFE 106. LFE 106 will receive a best technique (either from blind nodes or reference nodes) then determine a location using the best technique.

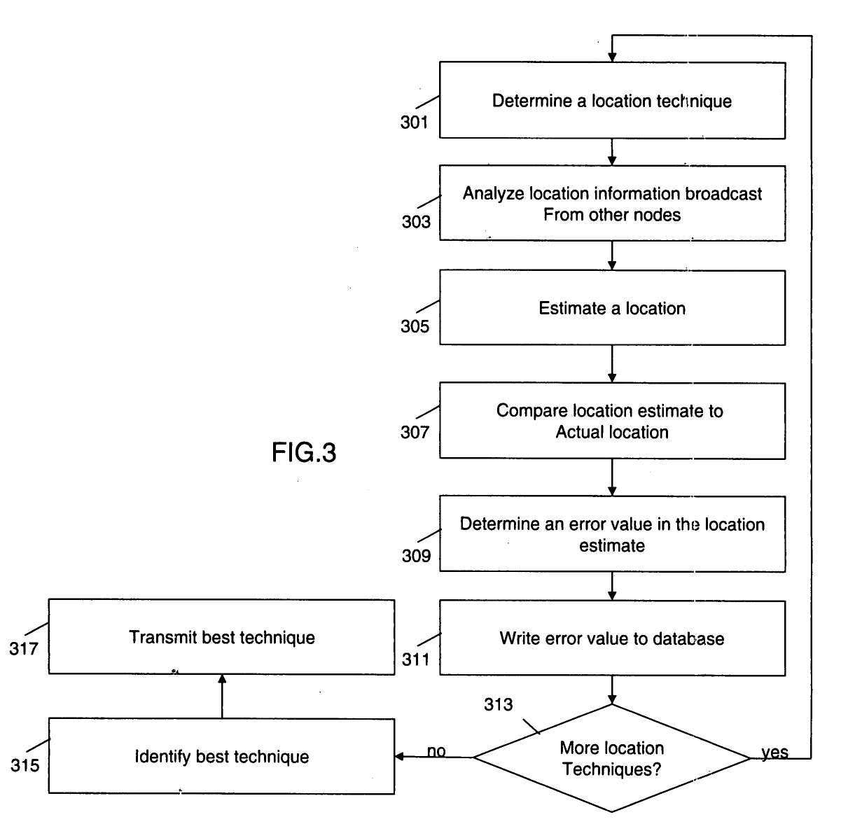

FIG. 3 is a flow chart showing the operation of node 200 when acting as a reference node. The logic flow begins at step 301 where logic circuitry 205 accesses database 207 to determine a location technique (e.g., a location algorithm and/or parameter) to utilize. As discussed above, such location techniques include, but are not limited to a signpost algorithm, a generic weighted-average technique, a triangulation technique, a multi-lateration technique, a maximum likelihood algorithm, a Global Positioning System technique, and associated parameters for the algorithms.

Once a technique is determined, logic circuitry 205 receives (via receiver 204) over-the-air signal 206 and determines location data broadcast from other reference nodes 105 (step 303). A location estimate is performed by logic circuitry 205 using the location technique at step 305, and this location estimate is compared to the reference nodes actual location at step 307, and an error value (e.g., a distance between the actual location and the estimated location) is determined by logic circuitry 205 at step 309. At step 311 the error value for the particular location technique is written to database 207.

The above procedures continues until error estimates for all location techniques within database 207 are obtained. In other words, a plurality of location estimates are calculated using a plurality of location techniques. Thus, at step 313, logic circuitry 205 determines if any other location techniques need to be analyzed, and if so, the logic flow returns to step 301. Once error estimates for all location techniques have been determined, a best location technique is identified (step 315) based on the plurality of location estimates, and the best technique is transmitted via transmitter 204 to all nodes (including blind nodes) within the communication system (step 317). Additionally, because the node is acting as a reference node, location data will also be transmitted to the other nodes.

As discussed, the best location technique may be simply broadcast to all nodes within communication range, or alternatively, may be provided on a node-by-node basis, when polled by a particular node. Additionally, while the above description was given with the best location technique being given to nodes within the communication system, alternatively, error estimates for the various techniques may be provided to the nodes, with the nodes themselves, determining a best location technique to utilize.

FIG. 4 is a flow chart showing operation of node 200 when acting as a blind node. The logic flow begins at step 401 where transceiver 204 receives a plurality of over-the-air signals from a plurality of reference nodes, each signal comprising a location and information regarding a best location technique. At step 403, a best location technique is determined by logic circuitry 205 from the plurality of best location techniques, and at step 405, logic circuitry 205 utilizes the plurality of locations and the best location technique to calculate a location estimate.

While the invention has been particularly shown and described with reference to a particular embodiment, it will be understood by those skilled in the art that various changes in form and details may be made therein without departing from the spirit and scope of the invention. For example, It is intended that such changes come within the scope of the following claims.

1. A method for determining a best location technique to use when locating a node, the method comprising the steps of:
receiving location data from a plurality of nodes;
calculating a plurality of location estimates using a plurality of location techniques, wherein the location estimates are based on the location data received from the plurality of nodes;
determining the best location technique based on the plurality of location estimates; and
providing information regarding the best location technique to other nodes to utilize when performing location.

2. The method of claim 1 wherein the step of providing information regarding the best location technique comprises the step of providing information regarding the best location technique to blind nodes to use when performing location.

3. The method of claim 2 wherein the step of receiving location data from the plurality of nodes comprises the step of receiving location data from a plurality of reference nodes.

4. The method of claim 3 wherein the step of providing information regarding the best location technique to other nodes comprises the step of transmitting the information via an over-the-air signal.

5. The method of claim 4 further comprising the step of:
transmitting location data to the other nodes to utilize when performing location.

6. The method of claim 5 wherein the step of calculating the plurality of location estimates using the plurality of location techniques comprises the step of calculating the plurality of location estimates using location techniques taken from the group consisting of signpost algorithm, a generic weighted-average technique, triangulation technique, multi-lateration technique, maximum likelihood algorithm, Global Positioning System technique, and associated parameters for the algorithms.

7. The method of claim 1 wherein the step of receiving location data from the plurality of nodes comprises the step of receiving location data from a plurality of reference nodes.

8. The method of claim 1 wherein the step of calculating the plurality of location estimates using the plurality of location techniques comprises the step of calculating the plurality of location estimates using location techniques taken from the group consisting of signpost algorithm, a generic weighted-average technique, triangulation technique, multi-lateration technique, maximum likelihood algorithm, Global Positioning System technique, and associated parameters for the algorithms.

9. The method of claim 1 wherein the step of providing information regarding the best location technique to other nodes comprises the step of transmitting the information via an over-the-air signal.

10. The method of claim 1 further comprising the step of:
transmitting location data to the other nodes to utilize when performing location.

11. A method for determining a best location technique to utilize when locating a node, the method comprising the steps of:
receiving location data from a plurality of reference nodes;
receiving information regarding best location techniques from the plurality of reference nodes; and
calculating a location estimate based on the location data and the information regarding the best location techniques.

12. The method of claim 11 wherein the step of receiving information regarding the best location technique comprises the step of receiving information regarding location techniques taken from the group consisting of signpost algorithm, a generic weighted-average technique, triangulation technique, multi-lateration technique, maximum likelihood algorithm, Global Positioning System technique, and associated parameters for the algorithms.

13. The method of claim 12 wherein the step of receiving location data comprises the step of receiving location data via an over-the-air signal.

14. The method of claim 13 wherein the step of receiving information regarding the best location technique comprises the step of receiving the information via an over-the-air signal.

15. An apparatus comprising:
a receiver receiving location data from a plurality of nodes;
logic circuitry calculating a plurality of location estimates using a plurality of location techniques, wherein the location estimates are based on the location data, the logic circuitry additionally determining a best location technique based on the plurality of location estimates; and
transmit circuitry transmitting information regarding the best location technique to other nodes to utilize when performing location.

16. The apparatus of claim 15 wherein the other nodes comprise blind nodes.

17. The apparatus of claim 16 wherein the location data is received from a plurality of reference nodes.

18. The method of claim 17 wherein the transmit circuitry comprises over-the-air transmit circuitry.

19. The method of claim 18 wherein the transmit circuitry additionally transmits location data to the other nodes to utilize when performing location.

20. The apparatus of claim 19 wherein the location techniques are taken from the group consisting of signpost algorithm, a generic weighted-average technique, triangulation technique, multi-lateration technique, maximum likelihood algorithm, Global Positioning System technique, and associated parameters for the algorithms.
